(19) United States
(12) Patent Application Publication
(10) Pub. No.: US 2008/0241433 A1
(43) Pub. Date: Oct. 2, 2008

(54) Artificial hedge structure

(76) Inventor: Wing Hon Li, Kwai Chung (CN)

Correspondence Address: ALBERT O COTA, 5460 WHITE OAK AVE, SUITE A-331, ENCINO, CA, 91316, US

(21) Appl. No.: 11/729,623

(22) Filed: Mar. 30, 2007

(51) Int. Cl. A01N 3/00

(52) U.S. Cl. 428/27

(57) ABSTRACT

An artificial hedge structure (10) comprising at least two panels, with each panel having a multiplicity of equidistant vertical members (26) and a multiplicity of equidistant horizontal spacers (28). A hinge assembly (44) comprising four hinge tabs (46), a hinge pin (50) and vertical spacers (52) is located between a first panel (12) and a second panel (42). The hinge assembly (44) allows the two panels to be positioned at an angle to each other, and allows multiple panels to be positioned in various shapes such as square or circular. Integrally attached to each panel's vertical member (26) and extending outward from the front and rear surfaces (78,80) are a multiplicity of needle clusters (60). Each cluster (60) has a plurality of resilient needles (66) that extend upward from a lower surface (62). Extending into the lower surface (62) is a cavity (64) that interfaces with a pin (40) that extends outward from the vertical members (26). Additionally, a support structure (72) is utilized to maintain the structure (10) in an upright position.

### TECHNICAL FIELD

The invention generally pertains to artificial plants, and more particularly to a modular design artificial hedge structure that can be assembled in a variety of shapes and sizes.

### BACKGROUND ART

One of the most popular and widely used methods of accentuating a location is the addition of plant life. While it is true that many locations, such as homes, businesses, etc., possess pre-existing plant life, it is often necessary to add other types depending on the wishes of the owner or climatic conditions which allow certain types of plant life to thrive.

It is also true that during the construction phase of new buildings the entire area is often stripped of all plant life in order to facilitate the construction of certain structures, such as parking garages. In this case, after the construction is completed it is necessary to create any individual or groups of plant life that are desired.

In the past, most people highly preferred actual living plant life to artificial plant life. The reason for this is because most early attempts to create artificial plant life resulted in plants that were obviously artificial. Over time though, the manufacturing technology of artificial plants has improved substantially. Today it is possible to purchase artificial plants that appear incredibly life-like, even upon close inspection.

The two most popular types of artificial plants are artificial flowers, which mimic the look and feel of many different types of flowers such as roses, lilies, etc., and artificial grass, which is also known as artificial turf and is used anywhere it is difficult to keep living grass alive, such as indoor sports facilities.

There are many benefits of using artificial plants, with the most obvious benefit being that artificial plants do not require much care. By simply cleaning and not exposing an artificial plant to severe physical contact, the plant can last indefinitely.

The only problem is that certain popular types of plants are either not made artificially, or they are limited in size and shape. One significant example is a hedge, which is used in many applications throughout the world. An artificial hedge that could be modularly assembled in any size or shape would be very beneficial.

### DISCLOSURE OF THE INVENTION

In its most basic design, the artificial hedge structure is comprised of at least two panels that are made of wood, metal or plastic, with plastic preferred. Each panel has a front surface, a rear surface, an upper edge, a lower edge, a right edge, a left edge, a multiplicity of equidistant vertical members, and a multiplicity of equidistant horizontal spacers.

Extending upward from the upper edge are a plurality of tabs, with each tab having a front-extending pin. Extending downward from the lower edge are also a plurality of tabs, with each tab having a bore extending therethrough that corresponds with the pin on the upward-extending tabs.

By inserting the pins on the upward-extending tabs into the bores on the downward-extending tabs, any number of panels can be attached together, thereby creating a modular structure. The pins are designed to frictionally fit into the bores to provide secure attachment of one panel to another.

A hinge assembly comprising four hinge tabs with each tab having a bore therethrough, a hinge pin, and vertical spacers, is located between two panels. A first panel has two hinge tabs integrally attached to the right edge, and the second panel has two hinge tabs integrally attached to the left edge. By interfacing the two groups of hinge tabs and then inserting the hinge pin sequentially through the bores that extend through the hinge tabs, the hinge assembly is created. Additionally, the vertical spacers are located between the two groups of hinge tabs. The vertical spacers also have a bore through each of them, into which the hinge pin is inserted.

Integrally attached to the vertical members and extending outward from each panel's front and rear surface are a multiplicity of equidistant pins. The pins are dimensioned to frictionally fit into a cavity that extends into the lower surfaces of a needle cluster. Each cluster has a lower surface with the cavity extending thereinto and a plurality of resilient needles that are integrally attached to, and extend upward from, the lower surface. Once each needle cluster is frictionally attached to each outward-extending pin on the front and rear surfaces, the artificial hedge structure has the appearance of a healthy, living hedge.

A support structure is utilized to maintain the hedge structure in an upright position. The support structure has a channel into which at least one panel is frictionally inserted. Once the panel is securely within the support structure, a stake can be inserted through a bore on the support structure, to maintain the hedge structure and the support structure at a desired location.

In view of the above disclosure, the primary object of the invention is to produce an artificial hedge structure that is easily assembled into a variety of shapes and sizes, and has the appearance of a healthy, living hedge.

In addition to the primary object, it is also an object of the invention to produce an artificial hedge structure that:
can be used indoors or outdoors, even in inclement weather,
can be easily disassembled and moved to a different location,
does not require any care, such as watering, trimming, etc.,
can be made in various colors or flocked to give the appearance of being snow-covered,
can be used along with living plants,
can be marketed and sold as kits for various applications, such as protective hedge, walkway liner, etc.,
can be laid flat and used as artificial grass/turf, and
is cost effective from both a manufacturer's and a consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a front elevational view of a first panel that comprises an element of the artificial hedge structure.

FIG. 2 is a bottom plan view of the first panel, for clarity only a limited number of pins are shown.

FIG. 3 is a top plan view of the first panel, for clarity only a pair of needle clusters are shown attached to the panels.

FIG. 4 is a front elevational view of a first panel attached to a second panel by means of a hinge assembly.

FIG. 5 is an exploded front view of a first panel, a second panel and a hinge assembly.

FIG. 6 is a perspective view of a needle cluster.

FIG. 7 is a front view of a first panel that has attached a multiplicity of needle clusters. The rear view of the first panel is a mirror image of the front view.

FIGS. 8 through 11 are front elevational views showing the artificial hedge structures of various shapes and sizes.

FIG. 12 is a perspective view of a typical support structure that can be used to support a panel.

FIG. 13 is a perspective view of the typical support structure shown with a panel attached.

### BEST MODE FOR CARRYING OUT THE INVENTION

The best mode for carrying out the invention is presented in terms of a preferred embodiment for an artificial hedge structure 10, (hereinafter “AHS 10”), which is designed to allow a realistic appearing hedge to be created. As a result of the AHS's modular design, any size or shape of hedge can be quickly and easily assembled. And, since the AHS 10 is artificial, it does not require any care, can be placed indoors or outdoors and will last indefinitely, even inclement weather.

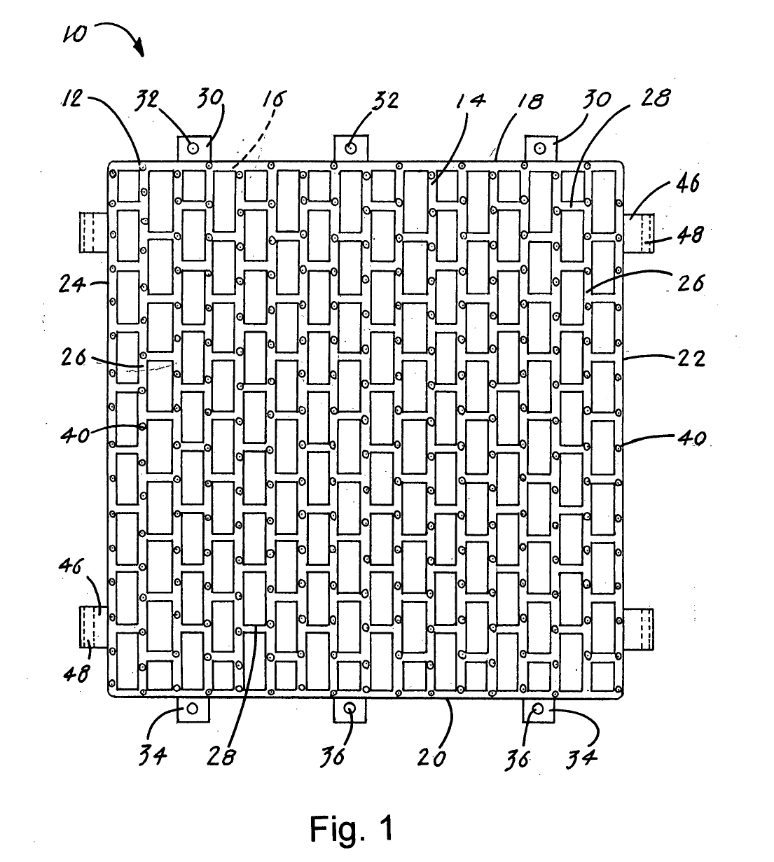

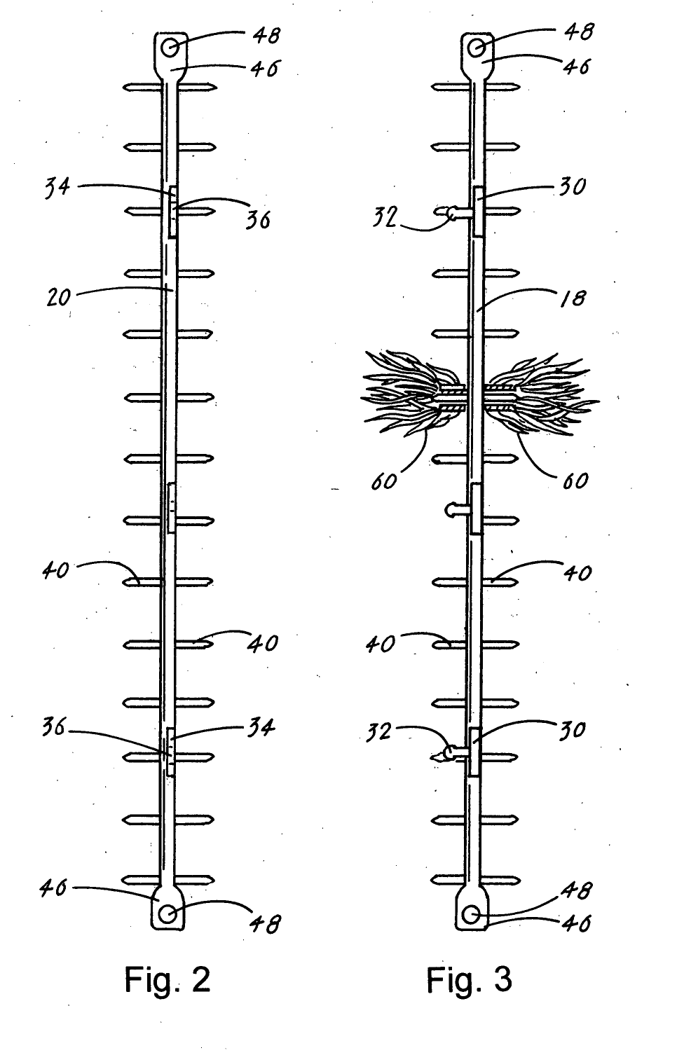

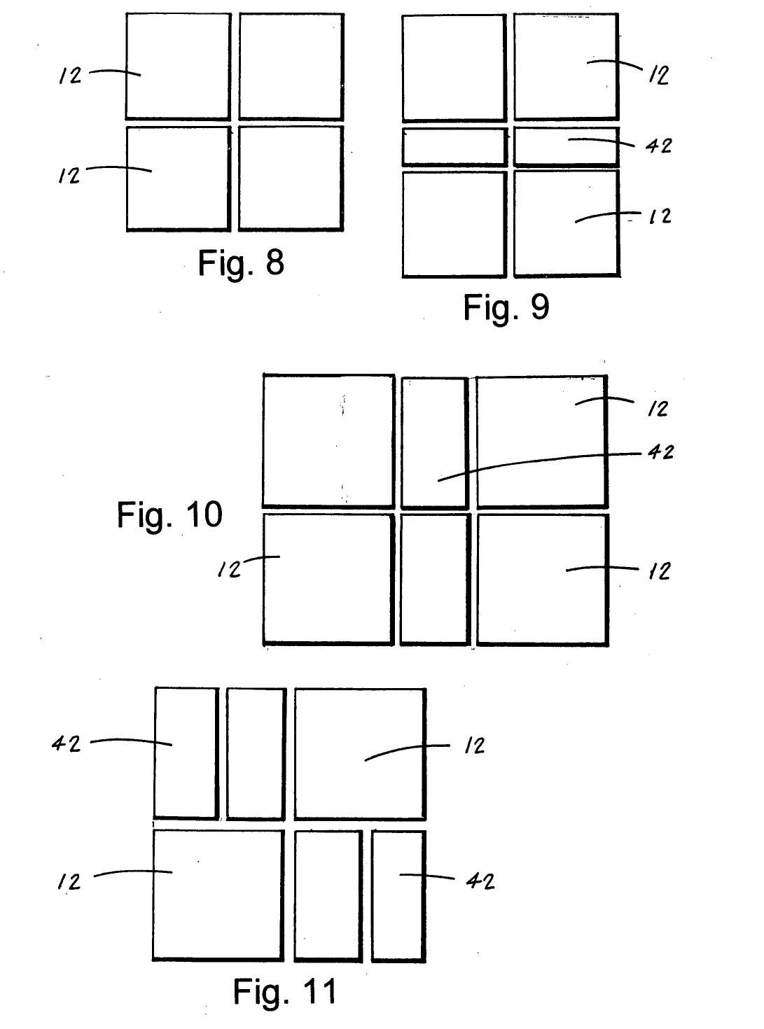

As shown in FIGS. 1-13, the AHS 10 is comprised of the following major elements: a first panel 12, a second pane 42, a hinge assembly 46, a multiplicity of needle clusters 60, and a support structure 72.

The first panel, as shown in FIGS. 1-3, is comprised of a front surface 14, a rear surface 16, an upper edge 18, a lower edge 20, a right edge 22, and a left edge 24. A multiplicity of equidistant vertical members 26 extend from the upper edge 18 to the lower edge 20 and a multiplicity of equidistant horizontal spacers 28 that are located between the vertical members 26. A plurality of tabs 30 extend upward from the upper edge 18, with each tab 30 having a front-extending pin 32, and a plurality of tabs 34 extend downward from the lower edge 20, with each tab 34 having a bore 36 extending therethrough that corresponds with the pin 32 on the upward-extending tabs 30. Additionally, a multiplicity of equidistant pins 40 are integrally attached to the vertical members 26 and extend outward from the front surface 14 and the rear surface 16.

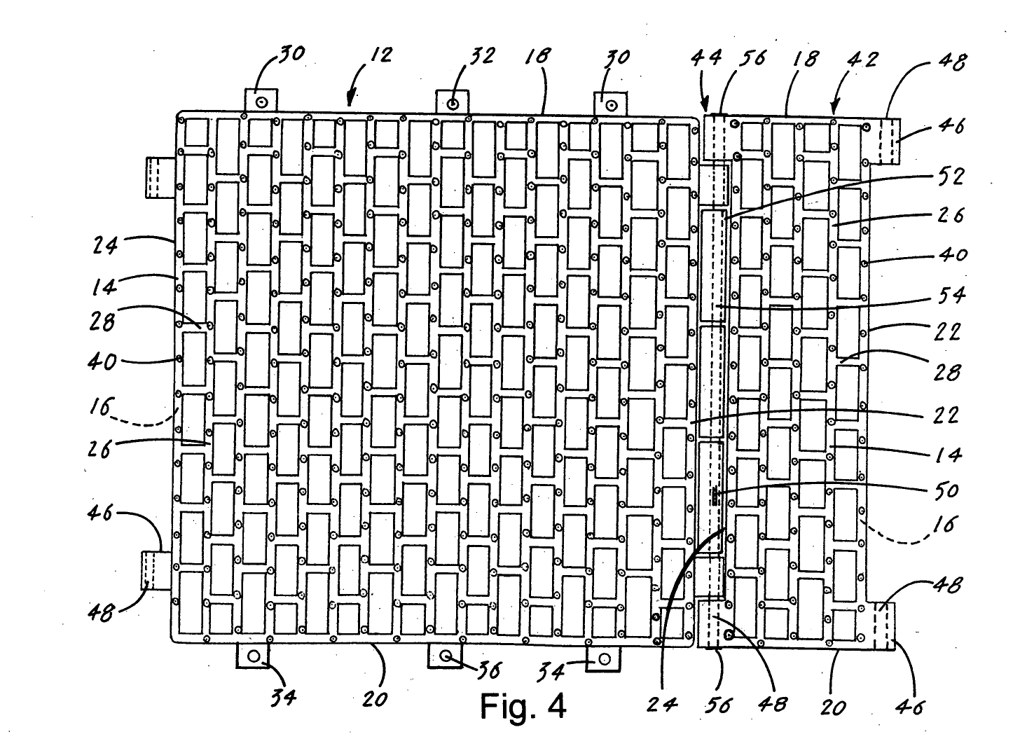

The second panel 42, as shown in FIG. 4, also has a front surface 14, a rear surface 16, an upper edge 18, a lower edge 20, a right edge 22, and a left edge 24. A multiplicity of equidistant vertical members 26 extend from the upper edge 18 to the lower edge 20, and a multiplicity of equidistant horizontal spacers 28 are located between the vertical members 26. Additionally, a multiplicity of equidistant pins 40 extend outward from the front surface 14 and the rear surface 16. It should be noted that although the second panel 42 is a separate entity, it possesses the same elements as the first panel 12, therefore the numerical element designation is shared between the first panel 12 and the second panel 42.

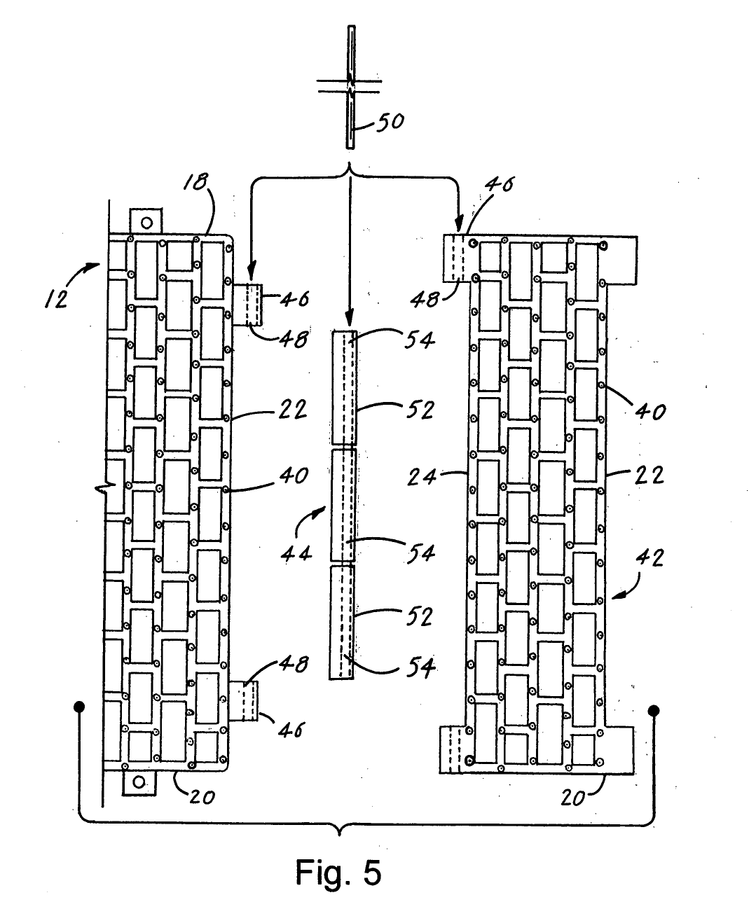

As shown in FIG. 5, the hinge assembly 44 is comprised of four hinge tabs 46 with each tab having a bore 48 therethrough, a hinge pin 50, and vertical spacers 52 with each spacer having a bore 54 therethrough. The hinge tabs 46 are integrally attached to corresponding locations on the right edge 22 of the first panel 12 and the left edge 24 of the second panel 42. When the two panels 12,42 are placed adjacent to each other, two hinge tabs 46 are aligned with one tab 46 above the other tab 46 near the upper edge 18, and one tab 46 above the other tab 46 near the lower edge 20, as shown in FIG. 5, thereby allowing the hinge pin 50 to be sequentially inserted through the bore 48 on each tab 46. The hinge pin 50 is also inserted through each bore 54 on the vertical spacers 52 which are located between the two hinge tabs 46 near the upper edge 18 and the two hinge tabs 46 near the lower edge 20, as also shown in FIG. 5. Once the hinge pin 50 is inserted through the hinge tabs 46 and the vertical spacers 52, the two panels 12,42 are securely attached together but can still be articulated about each other in an arc from 10 to 300 degrees. By attaching multiple panels together, either with a hinge assembly 44 between panels or just a panel to a panel, hedge structures of various sizes and shapes can be created. Additionally, to maintain the hinge pin 50 in position, an adhesive 56 can be applied to each end of the hinge pin 50.

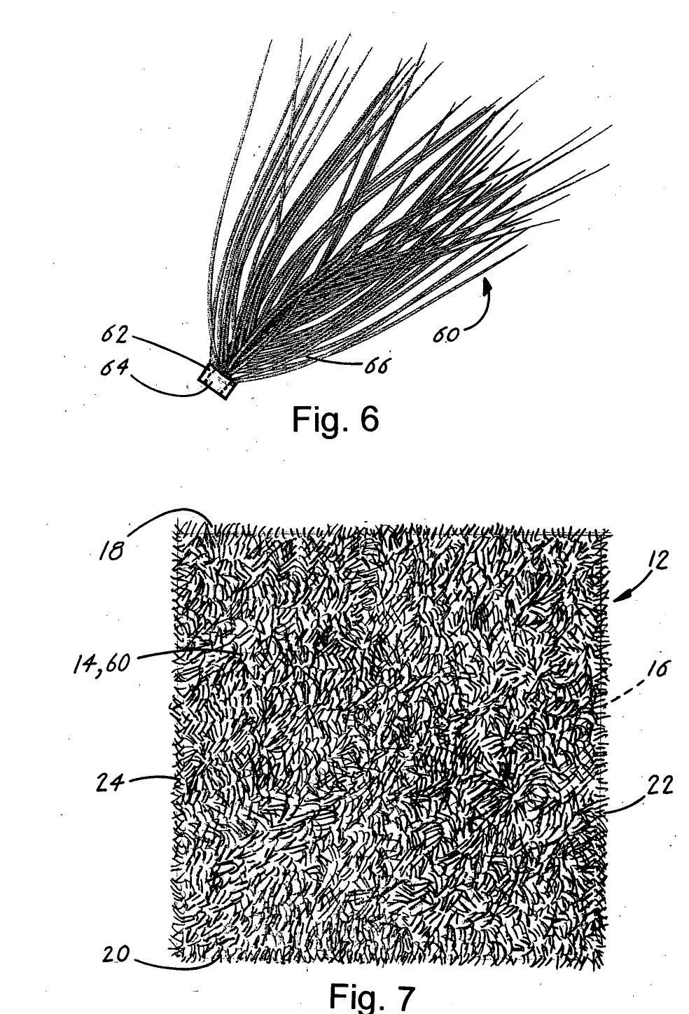

As shown in FIG. 6, each needle cluster 60 is comprised of a lower surface 62 having a cavity 64, and a plurality of resilient needles 66 that are integrally attached to, and extend upward from, the lower surface 62. The multiplicity of outward-extending equidistant pins 40 located on the front 14 and rear 16 surfaces are each dimensioned to frictionally fit into the cavity 64 on the lower surface 62 of each needle cluster 60. Once each cluster 60 is frictionally attached to each outward-extending pin 40 on the front 14 and rear 16 surfaces, as shown in FIG. 3, the AHS 10 has the appearance of a healthy, living hedge, as shown in FIG. 7. As previously disclosed, multiple AHSs 10 can be attached together by inserting the pins 32 on the tabs 30 into the bores 36 on the tabs 34 to create a large, unified hedge structure or hedge structures of various shapes and sizes, a shown in FIGS. 8-11.

The two panels 12,14, the hinge assembly 44 and the multiplicity of needle clusters 60 are all made of a material selected from the group consisting of polyethylene, ABS, acrylic, phenolic and polypropylene. Additionally, the two panels 12,42 can also be made of wood or metal. The hinge pin 50 is made of metal, plastic or wood, with metal preferred.

In order to create certain shapes and sizes of hedge structures, it is necessary to have panels that are not equally sized. Therefore, the second panel 42 can be ¼ (25%) the size of the first panel 12, as shown in FIG. 4; ½ (50%) the size of the first panel 12 (not shown); or ¾ (75%) the size of the first panel 12, (not shown). Additionally, the panels 12,42 can be square shaped and rectangular shaped, as shown in FIG. 4, or triangle shaped, (not shown) depending on the size and shape of the hedge structure that is being created.

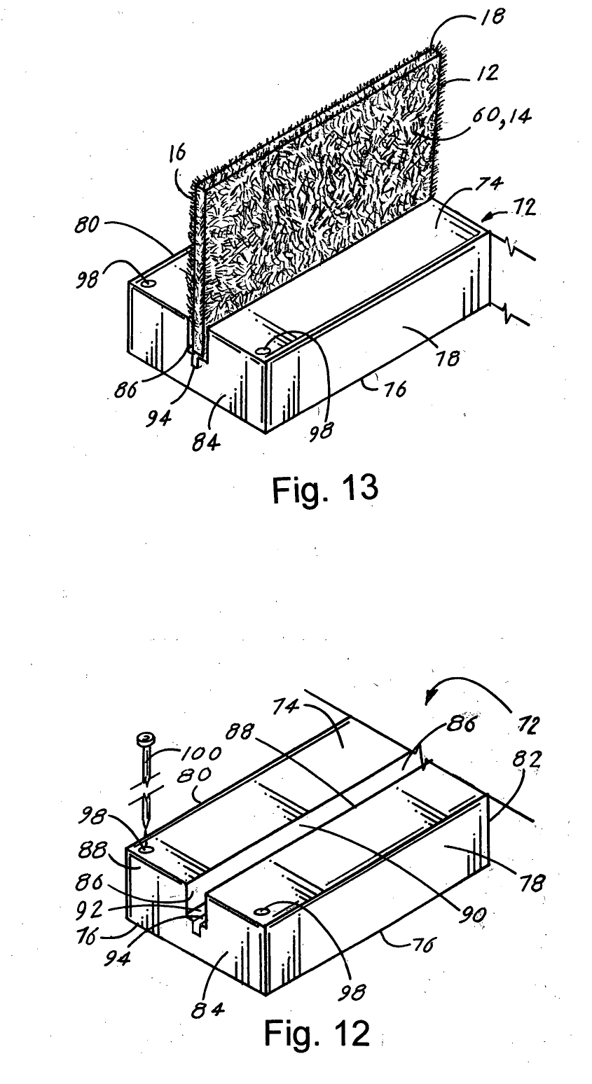

In order to maintain the AHS 10 in an upright position, a support structure 72 that is made of plastic, metal or wood is utilized. As shown in FIG. 12, the support structure 72 is comprised of an upper surface 74, a lower surface 76, a front surface 78, a rear surface 80, a right edge 82 and a left edge 84. Extending downward from the upper surface 74 is a channel 86 having a front surface 88, a rear surface 90 and a lower surface 92. Extending downward from the channel's 86 lower surface 92 is a slot 94. The channel is dimensioned to frictionally accept and maintain at least one-quarter of the vertical area of at least one panel with the needle clusters 60 attached. The slot 94 is dimensioned to frictionally accept the tabs 34 having bores 36 that extend downward from each panel's lower edge 20. As shown in FIG. 13, when a panel is placed into the support structure, the panel will be maintained in an upright position.

Additionally, the support structure 72 can further comprise at least one bore 98 that extends downward from the upper surface 74 to the ground below the support structure 72, as shown in FIG. 12. The bore 98 is dimensioned to accept a stake 100, as also shown in FIG. 12, that is used to maintain the support structure 72 on the ground at a particular location.

While the invention has been described in detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the claims.

1. An artificial hedge structure comprising at least one panel having a front surface, a rear surface, an upper edge, a lower edge, a right edge and a left edge, wherein extending outward from the front surface and the rear surface are a multiplicity of needle clusters, and wherein when said artificial hedge structure is placed upright normal to a surface, said structure has the appearance of a healthy, living hedge.

2. The structure as specified in claim 1 wherein said at least one panel and said multiplicity of needle clusters are made of plastic.

3. The structure as specified in claim 1 further comprising a support structure having an upper surface, a lower surface, a front surface, a rear surface, a right edge and a left edge, wherein extending downward from the upper surface is a channel having a front surface, a rear surface and a lower surface, wherein extending downward from the channel's lower surface is a slot, wherein the channel is dimensioned to frictionally accept and maintain at least one-quarter of the vertical area of at least one said panel with said needle clusters attached, and the slot is dimensioned to frictionally accept tabs having bores that extend downward from said panel's lower edge, and wherein when said at least one said panel is placed into said support structure, said panel will be maintained in an upright position.

4. The structure as specified in claim 3 wherein said support structure further having at least one bore that extends downward from the upper surface to the ground below said support structure, wherein the bore is dimensioned to accept a stake that is used to maintain said support structure at a particular location.

5. The structure as specified in claim 3 wherein said support structure is made of a material selected from the group consisting of plastic, metal and wood.

6. An artificial hedge structure comprising:
a) at least two panels comprising:
(1) a first panel having a front surface, a rear surface, an upper edge, a lower edge, a right edge, a left edge, a multiplicity of equidistant vertical members that extend from the upper edge to the lower edge, a multiplicity of equidistant horizontal spacers that are located between the vertical members, a plurality of tabs that extend upward from the upper edge with each tab having a front-extending pin, a plurality of tabs that extend downward from the lower edge with each tab having a bore extending therethrough that corresponds with the pin on the upward-extending tabs, and a multiplicity of equidistant pins that are integrally attached to the vertical members and extend outward from the front surface and the rear surface,
(2) a second panel having a front surface, a rear surface, an upper edge, a lower edge, a right edge, a left edge, a multiplicity of equidistant vertical members that extend from the upper edge to the lower edge, a multiplicity of equidistant horizontal spacers that are located between the vertical members, and a multiplicity of equidistant pins that extend outward from the front surface and the rear surface,
b) a hinge assembly that is comprised of four hinge tabs with each tab having a bore therethrough, a hinge pin, and vertical spacers with each spacer having a bore therethrough, wherein the hinge tabs are integrally attached to corresponding locations on the right edge of said first panel and the left edge of said second panel, and wherein when the two panels are placed adjacent to each other, two hinge tabs on each panel are aligned with one tab above the other tab near the upper edge, and one tab above the other near the lower edge, thereby allowing the hinge pin to be sequentially inserted through the bore on each tab and through the bore on each vertical spacer which are located between the two tabs near the upper edge and the two tabs near the lower edge, and wherein once the hinge pin is inserted through the hinge tabs and the vertical spacers, said two panels are securely attached together but can still be articulated about each other,
c) a multiplicity of needle clusters, wherein each cluster is comprised of a lower surface having a cavity, and a plurality of resilient needles that are integrally attached to, and extend upward from, the lower surface, wherein the multiplicity of outward-extending equidistant pins located on the front and near surfaces are each dimensioned to frictionally fit into the cavity on the lower surface of each needle cluster, wherein once each needle cluster is frictionally attached to each outward-extending pin on the front and rear surfaces, said artificial hedge structure has the appearance of a healthy, living hedge, and where multiple artificial hedge structures can be attached together by inserting the pins on the tabs with pins, into the bores on the tabs having bores to create a large, unified hedge structure, and
d) a support structure having an upper surface, a lower surface, a front surface, a rear surface, a right edge and a left edge, wherein extending downward from the upper surface is a channel having a front surface, a rear surface and a lower surface, wherein extending downward from the channel's lower surface is a slot, wherein the channel is dimensioned to frictionally accept and maintain at least one-quarter of the vertical area of at least one said panel with said needle clusters attached, and the slot is dimensioned to frictionally accept the tabs having bores that extend downward from said panel's lower edge, and wherein when said at least one said panel is placed into said support structure, said panel will be maintained in an upright position.

7. The structure as specified in claim 6 wherein said at least two panels, said hinge assembly, and said multiplicity of needle clusters are made of a material selected from the group consisting of: polyethylene, ABS, acrylic, phenolic and polypropylene.

8. The structure as specified in claim 6 wherein said at least two panels are made of wood.

9. The structure as specified in claim 6 wherein said at least two panels are made of metal.

10. The structure as specified in claim 6 wherein said support structure is made of a material selected from the group consisting of plastic, metal and wood.

11. The structure as specified in claim 6 wherein said panels are modular.

12. The structure as specified in claim 6 wherein said hinge pin is made of a material selected from the group consisting of metal, plastic and wood.

13. The structure as specified in claim 6 wherein said hinge pin is maintained in position by an adhesive that is applied to each end of said hinge pin.

14. The structure as specified in claim 6 wherein said panels can articulate about each other in an arc from 10 to 300 degrees.

15. The structure as specified in claim 6 wherein said second panel is ¼ (25%) the size of the first panel.

16. The structure as specified in claim 6 wherein said second panel is ½ (50%) the size of the first panel.

17. The structure as specified in claim 6 wherein said second panel is ¾ (75%) the size of the first panel.

18. The structure as specified in claim 17 wherein said first panel is square-shaped.

19. The structure as specified in claim 17 wherein said second panel is rectangular-shaped.

20. The structure as specified in claim 6 wherein said support structure further having at least one bore that extends downward from the upper surface to the ground below said support structure, wherein the bore is dimensioned to accept a stake that is sued to maintain said support structure at a particular location.
